(19) United States
(12) Patent Application Publication
(10) Pub. No.: US 2014/0060357 A1
(43) Pub. Date: Mar. 6, 2014

(54) IMAGING MEMBER

(71) Applicant: Bing HSIEH, Pleasanton, CA (US)

(72) Inventor: Bing HSIEH, Pleasanton, CA (US)

(73) Assignee: PALO ALTO RESEARCH CENTER INC., PALO ALTO, CA (US)

(21) Appl. No.: 13/601,817

(22) Filed: Aug. 31, 2012

(51) Int. Cl. B41F 1/18; C08G 77/26; G02B 5/22; B28B 1/14

(52) U.S. Cl. 101/450.1; 264/299; 528/34; 252/587

(57) ABSTRACT

An imaging member includes a surface layer comprising a silicone component having polar groups. The imaging member can be used with different types of fountain solutions.

### RELATED APPLICATIONS

The disclosure is related to U.S. patent application Ser. No. 13/095,714, filed on Apr. 27, 2011, titled “Variable Data Lithography System,” the disclosure of which is incorporated herein by reference in its entirety. The disclosure is related to co-pending U.S. Patent Application (Attorney Docket No. 056-0513), filed on the same day as the present disclosure, titled “Imaging Member for Offset Printing Applications,” the disclosure of which is incorporated herein by reference in its entirety; co-pending U.S. Patent Application (Attorney Docket No. 056-0512), filed on the same day as the present disclosure, titled “Imaging Member for Offset Printing Applications,” the disclosure of which is incorporated herein by reference in its entirety; co-pending U.S. Patent Application (Attorney Docket No. 056-0511), filed on the same day as the present disclosure, titled “Imaging Member for Offset Printing Applications,” the disclosure of which is incorporated herein by reference in its entirety; co-pending U.S. Patent Application (Attorney Docket No. 056-0510), filed on the same day as the present disclosure, titled “Imaging Member for Offset Printing Applications,” the disclosure of which is incorporated herein by reference in its entirety; co-pending U.S. Patent Application (Attorney Docket No. 056-0509, filed on the same day as the present disclosure, titled “Textured Imaging Member,” the disclosure of which is incorporated herein by reference in its entirety; co-pending U.S. Patent Application (Attorney Docket No. 056-0507), filed on the same day as the present disclosure, titled “Variable Lithographic Printing Process,” the disclosure of which is incorporated herein by reference in its entirety; co-pending U.S. Patent Application (Attorney Docket No. 056-0508), filed on the same day as the present disclosure, titled “Imaging Member for Offset Printing Applications,” the disclosure of which is incorporated herein by reference in its entirety; co-pending U.S. Patent Application (Attorney Docket No. 056-0506), filed on the same day as the present disclosure, titled “Imaging Member for Offset Printing Applications,” the disclosure of which is incorporated herein by reference in its entirety; co-pending U.S. Patent Application (Attorney Docket No. 056-0505), filed on the same day as the present disclosure, titled “Printing Plates Doped With Release Oil,” the disclosure of which is incorporated herein by reference in its entirety; and co-pending U.S. Patent Application (Attorney Docket No. 056-0451), filed on the same day as the present disclosure, titled “Methods and Systems for Ink-Based Digital Printing With Multi-Component, Multi-Functional Fountain Solution,” the disclosure of which is incorporated herein by reference in its entirety.

### FIELD OF DISCLOSURE

The present disclosure is related to imaging members as described herein. The imaging members are suitable for use in various marking and printing methods and systems, such as offset printing. Methods of making and using such imaging members are also disclosed, as are systems that contain such imaging members.

### BACKGROUND

Offset lithography is a common method of printing today. (For the purposes hereof, the terms “printing” and “marking” are interchangeable.) In a typical lithographic process a printing plate, which may be a flat plate, the surface of a cylinder, or belt, etc., is formed to have “image regions” formed of a hydrophobic/oleophilic material, and “non-image regions” formed of a hydrophilic/oleophobic material. The image regions correspond to the areas on the final print (i.e., the target substrate) that are occupied by a printing or marking material such as ink, whereas the non-image regions correspond to the areas on the final print that are not occupied by said marking material. The hydrophilic regions accept and are readily wetted by a water-based fluid, commonly referred to as a dampening fluid or fountain solution or release agent (typically consisting of water and a small amount of alcohol as well as other additives and/or surfactants to reduce surface tension). The hydrophobic regions repel release agent and accept ink, whereas the release agent formed over the hydrophilic regions forms a fluid “release layer” for rejecting ink. The hydrophilic regions of the printing plate thus correspond to unprinted areas, or “non-image areas”, of the final print.

The ink may be transferred directly to a target substrate, such as paper, or may be applied to an intermediate surface, such as an offset (or blanket) cylinder in an offset printing system. The offset cylinder is covered with a conformable coating or sleeve with a surface that can conform to the texture of the target substrate, which may have surface peak-to-valley depth somewhat greater than the surface peak-to-valley depth of the imaging plate. Also, the surface roughness of the offset blanket cylinder helps to deliver a more uniform layer of printing material to the target substrate free of defects such as mottle. Sufficient pressure is used to transfer the image from the offset cylinder to the target substrate. Pinching the target substrate between the offset cylinder and an impression cylinder provides this pressure.

Typical lithographic and offset printing techniques utilize plates which are permanently patterned, and are therefore useful only when printing a large number of copies of the same image (i.e. long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Accordingly, a lithographic technique, referred to as variable data lithography, has been developed which uses a non-patterned reimageable surface that is initially uniformly coated with a dampening fluid layer. Regions of the dampening fluid are removed by exposure to a focused radiation source (e.g., a laser light source) to form pockets. A temporary pattern in the dampening fluid is thereby formed over the non-patterned reimageable surface. Ink applied thereover is retained in the pockets formed by the removal of the dampening fluid. The inked surface is then brought into contact with a substrate, and the ink transfers from the pockets in the dampening fluid layer to the substrate. The dampening fluid may then be removed, a new uniform layer of dampening fluid applied to the reimageable surface, and the process repeated.

Different types of fountain solution are known, as are different types of surface layers suitable for imaging members. Problems may arise when the imaging member surface is not compatible with the fountain solution. It would be desirable to identify alternate materials for the imaging member surface layer which exhibit improved compatibility with different types of fountain solution and have good properties.

### SUMMARY

The present disclosure relates to imaging member for digital offset printing applications. The imaging members having a surface layer that includes silicone component having polar groups.

In an embodiment, imaging members may comprise a surface layer, wherein the surface layer includes a silicone component having polar groups. Polar groups of the silicone component may be selected from the group consisting of cyano, hydroxyl, ether, carbonyl, amide, and sulfone groups. In an embodiment, the polar groups may consist of cyano groups. The silicone component may be a polyorganosiloxane containing the polar groups in sidechains. The silicone component may be a random copolymer containing silicone units and ethylene units having the polar groups in sidechains. The silicone component may contain from about 1 to about 30 wt % of the polar groups. The silicone component may comprise an infra-red absorbing filler.

In an embodiment, methods of manufacturing an imaging member may include depositing a surface layer composition upon a mold; and curing the surface layer composition at an elevated temperature; wherein the surface layer composition comprises a silicone component having polar groups. The polar groups may be selected from the group consisting of cyano, hydroxyl, ether, carbonyl, amide, and sulfone groups. The polar groups may consist of cyano groups. The silicone component may be a polyorganosiloxane containing the polar groups in sidechains. The silicone component may be a random copolymer containing silicone units and ethylene units having the polar groups in sidechains. The silicone component may contain from about 1 to about 30 wt % of the polar groups. The surface layer may include an infrared-absorbing filler.

In an embodiment, variable lithographic printing processes may include applying a fountain solution to an imaging member surface; forming a latent image by evaporating the fountain solution from selective locations on the imaging member surface to form non-image areas and image areas; developing the latent image by applying an ink composition comprising an ink component to the image areas; and transferring the developed latent image to a receiving substrate; wherein the imaging member surface comprises a silicone component having polar groups. The fountain solution may be an aqueous solution, a silicone liquid, or a silicone oil. The fountain solution may be D4. The polar groups may be selected from the group consisting of cyano, hydroxyl, ether, carbonyl, amide, and sulfone groups. The silicone component may be a polyorganosiloxane containing the polar groups in sidechains. The silicone component may contain from about 1 to about 30 wt % of the polar groups.

These and other non-limiting aspects of the disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a variable lithographic printing apparatus in which the imaging members of the present disclosure may be used.

### DETAILED DESCRIPTION

A more complete understanding of the processes and apparatus disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “room temperature” refers to 25° C.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

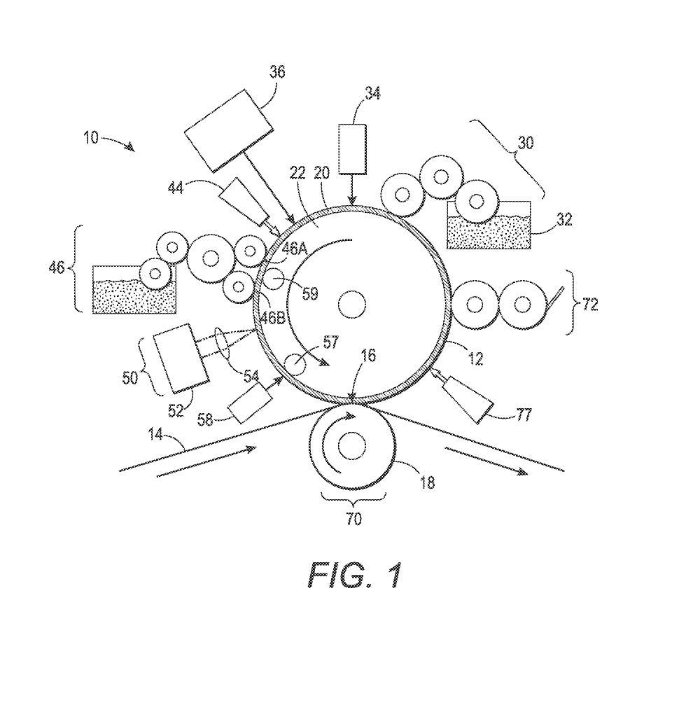

FIG. 1 illustrates a system for variable data lithography in which the imaging members of the present disclosure may be used. The system 10 comprises an imaging member 12. The imaging member comprises a substrate 22 and a reimageable surface layer 20. The surface layer is the outermost layer of the imaging member, i.e. the layer of the imaging member furthest from the substrate. As shown here, the substrate 22 is in the shape of a cylinder; however, the substrate may also be in a belt form, etc. Note that the surface layer is usually a different material compared to the substrate, as they serve different functions.

In the depicted embodiment the imaging member 12 rotates counterclockwise and starts with a clean surface. Disposed at a first location is a dampening fluid subsystem 30, which uniformly wets the surface with dampening fluid 32 to form a layer having a uniform and controlled thickness. Ideally the dampening fluid layer is between about 0.15 micrometers and about 1.0 micrometers in thickness, is uniform, and is without pinholes. As explained further below, the composition of the dampening fluid aids in leveling and layer thickness uniformity. A sensor 34, such as an in-situ non-contact laser gloss sensor or laser contrast sensor, is used to confirm the uniformity of the layer. Such a sensor can be used to automate the dampening fluid subsystem 30.

At optical patterning subsystem 36, the dampening fluid layer is exposed to an energy source (e.g. a laser) that selectively applies energy to portions of the layer to image-wise evaporate the dampening fluid and create a latent “negative” of the ink image that is desired to be printed on the receiving substrate. Image areas are created where ink is desired, and non-image areas are created where the dampening fluid remains. An optional air knife 44 is also shown here to control airflow over the surface layer 20 for the purpose of maintaining clean dry air supply, a controlled air temperature, and reducing dust contamination prior to inking. Next, an ink composition is applied to the imaging member using inker subsystem 46. Inker subsystem 46 may consist of a “keyless” system using an anilox roller to meter an offset ink composition onto one or more forming rollers 46A, 46B. The ink composition is applied to the image areas to form an ink image.

A rheology control subsystem 50 partially cures or tacks the ink image. This curing source may be, for example, an ultraviolet light emitting diode (UV-LED) 52, which can be focused as desired using optics 54. Another way of increasing the cohesion and viscosity employs cooling of the ink composition. This could be done, for example, by blowing cool air over the reimageable surface from jet 58 after the ink composition has been applied but before the ink composition is transferred to the final substrate. Alternatively, a heating element 59 could be used near the inker subsystem 46 to maintain a first temperature and a cooling element 57 could be used to maintain a cooler second temperature near the nip 16.

The ink image is then transferred to the target or receiving substrate 14 at transfer subsystem 70. This is accomplished by passing a recording medium or receiving substrate 14, such as paper, through the nip 16 between the impression roller 18 and the imaging member 12.

Finally, the imaging member should be cleaned of any residual ink or dampening fluid. Most of this residue can be easily removed quickly using an air knife 77 with sufficient air flow. Removal of any remaining ink can be accomplished at cleaning subsystem 72.

The imaging member surface generally has a tailored topology. Put another way the surface has a micro-roughened surface structure to help retain fountain solution/dampening fluid in the non-image areas. These hillocks and pits that make up the surface enhance the static or dynamic surface energy forces that attract the fountain solution to the surface. This reduces the tendency of the fountain solution to be forced away from the surface by roller nip action. The imaging member plays multiple roles in the variable data lithography printing process, which include: (1) wetting with the fountain solution, (2) creation of the latent image, (3) inking with the offset ink, and (4) enabling the ink to lift off and be transferred to the receiving substrate. Some desirable qualities for the imaging member, particularly its surface, include high tensile strength to increase the useful service lifetime of the imaging member. The surface layer should also weakly adhere to the ink, yet be wettable with the ink, to promote both uniform inking of image areas and to promote subsequent transfer of the ink from the surface to the receiving substrate. Finally, some solvents have such a low molecular weight that they inevitably cause some swelling of the imaging member surface layer. Wear can proceed indirectly under these swell conditions by causing the release of near infrared laser energy-absorbing particles at the imaging member surface, which then act as abrasive particles. Desirably, the imaging member surface layer has a low tendency to be penetrated by solvent.

As previously mentioned, different types of fountain solution can be used, such as fluorinated non-aqueous fountain solutions like the NOVEC fluids available from 3M, silicone oils, and water/aqueous solutions. However, the imaging member surfaces are typically only compatible with one type of fountain solution. The imaging members of the present disclosure have a surface that includes a silicone component having polar groups. They are more compatible with different types. They provide oil resistance and can thus be used with silicone oils. They have improved wetting characteristics with aqueous fountain solutions. They have a slower pull back rate with fluorinated non-aqueous fountain solutions.

The surface layer is made from a silicone component that has polar groups. The term “silicone” is well understood in the arts and refers to polyorganosiloxanes having a backbone formed from silicon and oxygen atoms and sidechains containing carbon and hydrogen atoms. Other functional groups may be present in the silicone rubber, for example vinyl, nitrogen-containing, mercapto, hydride, and silanol groups, which are used to link siloxane chains together during crosslinking. The term “fluorosilicone” refers to polyorganosiloxanes having a backbone formed from silicon and oxygen atoms and sidechains containing carbon, hydrogen, and fluorine atoms. Fluorosilicones may be considered to be a subset of silicones.

The polyorganosiloxane contains polar groups in either (1) the sidechains that extend from the silicon atoms; or (2) as sidechains extending from carbon atoms that are incorporated into the backbone of the polyorganosiloxane. In particular embodiments, the polar groups are selected from the group consisting of cyano, hydroxyl, nitrogen, ether, carbonyl, sulfone and fluoroalkyl groups. The polyorganosiloxane may include sidechains which do not contain polar groups may be, for example, alkyl or aryl. A given sidechain may contain more than one such polar group, and the sidechains in the overall polyorganosiloxane may be different from each other. However, in particular embodiments, the polar groups in the siloxane component are all the same, or in other words the siloxane component consists of the given polar group.

The term “cyano” refers to the —CN radical. Commercial cyano containing additives for silicones include beta-allyloxypropionitrile, 3-butenenitrile, 2-cyanoethyltriethoxysilane, 2-cyanoethyltrimethoxysilane, 3-cyanopropylmethoxysilane, 3-cyanobutyl methyldimethoxysilcane, and the like.

The term “hydroxyl” refers to the —OH radical. Commercial OH containing additives for silicones include 2-(allyloxy)ethanol, 6-Hexen-1-ol, 5-Hexene-1-ol and related alcohols that contain a vinyl groups.

The terms “nitrogen” refers to the amino and nitrogen containing radical. Commercial amino compounds that can be incorporated in silicones of the present invention include 1,3-bis(2-aminoethylaminomethyl)-tetramethyl disiloxane, bis(3-aminopropyl)tetramethyl disiloxane, 3-aminopropyl triethoxylsilane, 10-undecenylamine, bis[3-tri methoxysilyl]propyl]ethylenedimane, triallyl cyanurate, N-(3-triethoxysilylpropyl)-4,5-dihydroimidazole, 2-(tri methoxysilyethyl)pyridine, triallyl cyanurate, and the like.

The term “ether” refers to a radical that contains an oxygen atom bonded to two different carbon atoms, e.g. —R₁—O—R₂. Commerical ether materials include include allyloxy(diethylene oxide)methyl ether, allyloxy(polyethylene oxides), allyloxy(polyethylene oxide)methyl ether, allyloxy(triethylene oxide)methyl ether, poly(ethylene oxide)diallyl ether, methoxyltriethylenoxy propyltrimethoxysilane, bis(3-triethoxysilylpropoxy-2-hydroxypropoxy)polyethylene oxide, bis[(3-methyldimethoxysilyl)propyl]polypropylene oxide, tripropylene glycol diacryalte, and the like.

The term “carbonyl” refers to a radical having an oxygen atom double bonded to a single carbon atom which is in turn bound to two different carbon atoms, e.g. —R₁—CO—R₂. Major classes of carbonyl compounds include esters, ketones, carbonates, amides, ureas, urethanes. Commercially compounds of this type include, 2-hydroxy-4-allyloxybenzophenone, triethoxysilylpropylethylcarbamate, allyl metacrylate, vinyl ethylene carbonate, N-(3-triethoxysilylpropyl)gluconamide, bis(tri methoxysilylpropyl)urea, tris(3-tri methoxysilylpropyl)isocyanurate, N-(3-triethoxysilylpropyl)-4-hydroxy-butyramide, N-(triethoxysilylpropyl)-O-poly(ethylene oxide urethane, and the like. The term “sulfone” refers to a radical of the formula —R₁—SO₂—R₂. One commercial compound of this type is (2-triethoxysilylpropoxy)ethoxysulfolane.

The term “fluoroalkyl” refer to fluorinated and perfluorinated alkyl groups. Commercial compounds of this class include allyl heptafluoroisopropyl ether, allyl 1H, 1H-heptafluorobutyl ether, allyl 2,2,3,3,4,4,5,5-octafluoropentyl ether, nonafluorohexyltriethoxysilane, (3,3,3-trifluoropropyl)trimethoxysilane, and the like.

The term “alkyl” as used herein refers to a radical which is composed entirely of carbon atoms and hydrogen atoms which is fully saturated. The alkyl radical may be linear, branched, or cyclic. Linear alkyl radicals generally have the formula —CₙH₂ₙ₊₁.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms).

In some embodiments, the polar groups are present in an amount of from about 1 to about 30 wt % of the total weight of the silicone, including from about 3 to about 20 wt % and from about 5 to about 10 wt %.

The polar groups may be synthesized in the silicone component by the addition of suitable co-curative compounds to commercially available formulations prior to curing. For example, a cyano polar group can be incorporated into a silicone by the addition of, for example, 2-cyanoethyltrimethoxysilane or 2-cyanoethyltriethoxysilane. As another example, an ether group and a cyano group can be incorporated by the addition of, for example, beta-allyloxypropionitrile. The vinyl group of this compound is incorporated into the backbone of the silicone component. Such polysiloxanes could be considered to be random copolymers or block copolymers.

The curing may be performed at room temperature with a platinum catalyst for curing. Exemplary commercially available formulation that can be modified to include polar groups include ELASTOSIL RT 622 from Wacker. This is a poly(dimethyl siloxane) containing functional groups such as vinyl or hydride that permit addition crosslinking.

Curing may also be performed at room temperature for a moisture cured system, with or without a tin or a titanate catalyst. Exemplary commercially available products include Dow Corning Toray SE9187. This is a poly(dimethyl siloxane) containing a mono- and a di-trimethoxysilyloxy terminal groups that serve as the crosslinking groups. Diisopropoxy di(ethoxyacetoacetyl)titanate is the catalyst.

The silicone rubber may be loaded with an infrared-absorbing filler that increases energy absorption. This aids in efficient evaporation of the fountain solution. In particular, it is contemplated that the energy is infra-red (IR) energy. In specific embodiments, the metal oxide filler is iron oxide (FeO). Other infrared-absorbing fillers include, but are not limited to, graphene, graphite, carbon nanotubes, and carbon fibers. The metal oxide filler may have an average particle size of from about 2 nanometers to about 10 microns.

The infrared-absorbing filler may make up from about 5 to about 20 weight percent of the surface layer, including from about 7 to about 15 weight percent. The silicone rubber may make up from about 80 to about 95 weight percent of the surface layer, including from about 85 to about 93 weight percent.

If desired, the surface layer may also include other fillers, such as silica. Silica can help increase the tensile strength of the surface layer and increase wear resistance. Silica may be present in an amount of from about 2 to about 30 weight percent of the surface layer, including from about 5 to about 30 weight percent. However, common carbon fillers with appreciable amounts of sulfur should not be used as fillers in addition to cured silicones, since these fillers have been found to inhibit the curing process of the silicone rubber.

The surface layer may have a thickness of from about 0.5 microns (μm) to about 4 millimeters (mm), depending on the requirements of the overall printing system.

The surface layer composition may be provided in a surface layer coating solution. The surface layer coating solution may also contain a surfactant, if desired. Any suitable and known surfactant, or mixture of two or more surfactants, can be used. When present, the surfactant can be incorporated into the surface layer coating solution in any desired amount, such as to provide a coating solution that achieves defect-free or substantially defect-free coatings. In embodiments, the amount of surfactant included in the coating solution can be, for example, from about 0.01 or from about 0.1 to about 10 or to about 15% by weight, such as from about 0.5 to about 5% or to about 6% by weight of the coating solution.

The surface layer may be prepared in a mold as a 1 to 2 millimeter thick layer or coated onto a substrate as a 10 to 30 micron thick layer.

Further disclosed are processes for variable data lithographic printing. The processes include applying a fountain solution/dampening fluid to an imaging member comprising an imaging member surface. A latent image is formed by evaporating the fountain solution from selective locations on the imaging member surface to form non-image areas and image areas; developing the latent image by applying an ink composition to the image areas; and transferring the developed latent image to a receiving substrate. The imaging member surface comprises a silicone component having polar groups.

The surface layers including the silicone components of the present disclosure can be used with different types of fountain solutions/dampening fluids. For example, they can be used with volatile silicone liquids, silicone oils, and aqueous solutions.

An exemplary volatile silicone liquid is a linear siloxane having the structure of Formula (II):

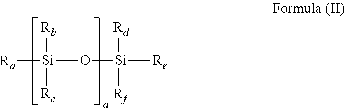

wherein Rₐ, R_{b}, R_{c}, R_{d}, Rₑ, and R_{f} are each independently hydrogen, alkyl, fluoroalkyl, or perfluoroalkyl; and a is an integer from 1 to about 5. In some specific embodiments, Rₐ, R_{b}, R_{c}, R_{d}, Rₑ, and R_{f} are all alkyl. In more specific embodiments, they are all alkyl of the same length (i.e. same number of carbon atoms).

In this regard, the term “fluoroalkyl” as used herein refers to a radical which is composed entirely of carbon atoms and hydrogen atoms, in which one or more hydrogen atoms may be (i.e. are not necessarily) substituted with a fluorine atom, and which is fully saturated. The fluoroalkyl radical may be linear, branched, or cyclic. It should be noted that an alkyl group is a subset of fluoroalkyl groups.

The term “perfluoroalkyl” as used herein refers to a radical which is composed entirely of carbon atoms and fluorine atoms which is fully saturated and of the formula —CₙF₂ₙ₊₁. The perfluoroalkyl radical may be linear, branched, or cyclic. It should be noted that a perfluoroalkyl group is a subset of fluoroalkyl groups, and cannot be considered an alkyl group.

Exemplary compounds of Formula (II) include hexamethyldisiloxane and octamethyltrisiloxane, which are illustrated below as Formulas (II-a) and (II-b):

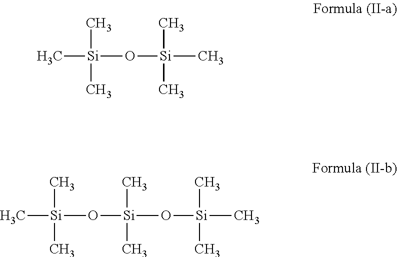

In other embodiments, the volatile silicone liquid is a cyclosiloxane having the structure of Formula (III):

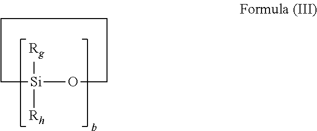

wherein each R_{g} and Rₕ is independently hydrogen, alkyl, fluoroalkyl, or perfluoroalkyl; and b is an integer from 3 to about 8. In some specific embodiments, all of the R_{g} and Rₕ groups are alkyl. In more specific embodiments, they are all alkyl of the same length (i.e. same number of carbon atoms).

Exemplary compounds of Formula (III) include octamethylcyclotetrasiloxane (aka D4) and decamethylcyclopentasiloxane (aka D5), which are illustrated below as Formulas (III-a) and (III-b):

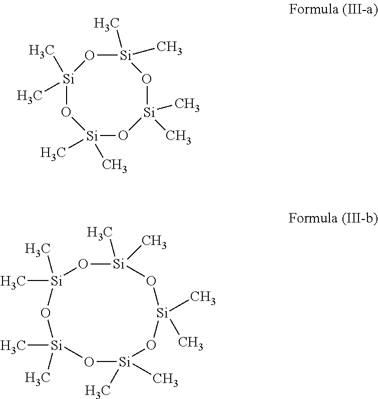

In other embodiments, the volatile silicone liquid is a branched siloxane having the structure of Formula (IV):

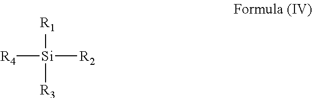

wherein R₁, R₂, R₃, and R₄ are independently alkyl or —OSiR₁R₂R₃.

An exemplary compound of Formula (IV) is methyl trimethicone, also known as methyltris(trimethylsiloxy)silane, which is commercially available as TMF-1.5 from Shin-Etsu, and shown below with the structure of Formula (IV-a):

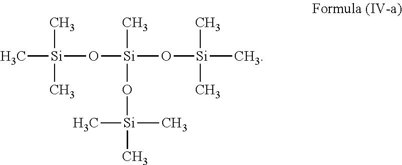 [SMILES: C[Si](C)(C)O[Si](C)(O[Si](C)(C)C)O[Si](C)(C)C]

Any of the above described hydrofluoroethers/perfluorinated compounds are miscible with each other. Any of the above described silicones are also miscible with each other. This allows for the tuning of the dampening fluid for optimal print performance or other characteristics, such as boiling point or flammability temperature. Combinations of these hydrofluoroether and silicone liquids are specifically contemplated as being within the scope of the present disclosure. It should also be noted that the silicones of Formulas (II), (III), and (IV) are not considered to be polymers, but rather discrete compounds whose exact formula can be known.

In particular embodiments, it is contemplated that the dampening fluid comprises a mixture of octamethylcyclotetrasiloxane (D4) and decamethylcyclopentasiloxane (D5). Most silicones are derived from D4 and D5, which are produced by the hydrolysis of the chlorosilanes produced in the Rochow process. The ratio of D4 to D5 that is distilled from the hydrolysate reaction is generally about 85% D4 to 15% D5 by weight, and this combination is an azeotrope.

In particular embodiments, it is contemplated that the dampening fluid comprises a mixture of octamethylcyclotetrasiloxane (D4) and hexamethylcyclotrisiloxane (D3), the D3 being present in an amount of up to 30% by total weight of the D3 and the D4. The effect of this mixture is to lower the effective boiling point for a thin layer of dampening fluid.

The ink compositions contemplated for use with the present disclosure generally include a colorant and a plurality of selected crosslinkable compounds. The crosslinkable compounds can be cured under ultraviolet (UV) light to fix the ink in place on the final receiving substrate. As used herein, the term “colorant” includes pigments, dyes, quantum dots, mixtures thereof, and the like. Dyes and pigments have specific advantages. Dyes have good solubility and dispersibility within the ink vehicle. Pigments have excellent thermal and light-fast performance. The colorant is present in the ink composition in any desired amount, and is typically present in an amount of from about 10 to about 40 weight percent (wt %), based on the total weight of the ink composition, or from about 20 to about 30 wt %. Various pigments and dyes are known in the art, and are commercially available from suppliers such as Clariant, BASF, and Ciba, to name just a few.

The ink compositions may have a viscosity of from about 5,000 to about 40,000 centipoise at 25° C. and infinite shear, including a viscosity of from about 7,000 to about 15,000 cps. These ink compositions may also have a surface tension of at least about 25 dynes/cm at 25° C., including from about 25 dynes/cm to about 40 dynes/cm at 25° C. These ink compositions possess many desirable physical and chemical properties. They are compatible with the materials with which they will come into contact, such as the dampening fluid, the surface layer of the imaging member, and the final receiving substrate. They also have the requisite wetting and transfer properties. They can be UV-cured and fixed in place. They also have a good viscosity; conventional offset inks usually have a viscosity above 50,000 cps, which is too high to use with nozzle-based inkjet technology. In addition, one of the most difficult issues to overcome is the need for cleaning and waste handling between successive digital images to allow for digital imaging without ghosting of previous images. These inks are designed to enable very high transfer efficiency instead of ink splitting, thus overcoming many of the problems associated with cleaning and waste handling. The ink compositions of the present disclosure do not gel, whereas regular offset inks made by simple blending do gel and cannot be used due to phase separation.

Aspects of the present disclosure may be further understood by referring to the following examples. The examples are illustrative, and are not intended to be limiting embodiments thereof.

### EXAMPLES

Cyano functional groups were incorporated into both moisture- and platinum-cured silicones. A co-curative such as 2-cyanoethylmethoxysilane or 2-cyanoethyltriethoxysilane was added into Dow Corning's Toray SE9187L to prepare silicone with from about 5 to about 10 wt % of cyano groups. The resulting cyano-silicones exhibited reduced swelling upon exposure to silicone fluids such as D4. Silicone fluid resistance may be further improved by increasing the wt % of the cyano groups.

### Example 1

This example shows a typical procedure for a moisture cured silicone. silicone. Into a 30 ml polypropylene bottle was added Dow Corning's Toray SE 9187 (4.75 g) and 2-cyanoethyl trimethoxysilane (0.25 g, available from Gelest). The resulting mixture was shaken for 30 min using a Burrell Wrist-Action® shaker, then poured into a polypropylene dish, and allowed to cure for two days. The room temperature cured sample was further cured in an oven at 100 degrees Celsius overnight to give a cyano modified silicone.

### Example 2

This example shows another typical procedure for a moisture cured silicone containing carbon black. Into a 30 ml polypropylene bottle was added Dow Corning's Toray SE 9187 (9.0 g), 2-cyanoethyl trimethoxysilane (0.45 g, available from Gelest), and Cabot Vulcan XC72 carbon black (1.0 g,). Steel ball (15 g) was added to the mixture. The resulting mixture was shaken overnight using a Burrell Wrist-Action® Shaker, then poured into a polypropylene dish, and allowed to cure for two days. The room temperature cured sample was further cured in an oven at 100 degrees Celsius overnight to give a carbon-filled cyano-modified silicone.

### Example 3

This example illustrates a typical procedure for a platinum cured silicone containing carbon black. Into a 60 ml polypropylene bottle was added Cabot Vulcan XC72 carbon black (1.7 g), toluene (28.4 g), and stainless steel beads (25 g). The resulting mixture was shaken overnight using a Burrell Wrist-Action® shaker. Into the resulting mixture was added a vinyl-terminated polydimethylsiloxane (9.0 g, Gelest DMS-V31), platinum catalyst (0.9 g, Gelest SIP6831.2 pt conc. of 2.1%-2.4%), and 3-(Allyloxy)propionitrile (2.0 g). The resulting mixture was shaken for 30 min to give a part A mixture. During this time, part B solution was prepared by adding DMS-V31 (1.2 g), a polymethylhydrosilane HMS-301 from Gelest (4.8g), toluene (5 g) in a 20 ml vial. Part B solution was added all at once into the part A mixture, and the resultant mixture was shaken for 10 min. The resultant mixture was poured into a polypropylene dish, and allowed to cure for two days, followed by curing at 100 degrees Celsius overnight to yield a cyano-modified silicone.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

What is claimed is:

1. An imaging member comprising a surface layer, wherein the surface layer includes a silicone component having polar groups.

2. The imaging member of claim 1, wherein the polar groups are selected from the group consisting of cyano, hydroxyl, ether, carbonyl, amide, and sulfone groups.

3. The imaging member of claim 1, wherein the polar groups consist of cyano groups.

4. The imaging member of claim 1, wherein the silicone component is a polyorganosiloxane containing the polar groups in sidechains.

5. The imaging member of claim 1, wherein the silicone component is a random copolymer containing silicone units and ethylene units having the polar groups in sidechains.

6. The imaging member of claim 1, wherein the silicone component contains from about 1 to about 30 wt % of the polar groups.

7. The imaging member of claim 1, wherein the surface layer further comprises an infrared-absorbing filler.

8. A method of manufacturing an imaging member surface layer, comprising:
depositing a surface layer composition upon a mold; and
curing the surface layer composition at an elevated temperature;
wherein the surface layer composition comprises a silicone component having polar groups.

9. The method of claim 8, wherein the polar groups are selected from the group consisting of cyano, hydroxyl, ether, carbonyl, amide, and sulfone groups.

10. The method of claim 8, wherein the polar groups consist of cyano groups.

11. The method of claim 8, wherein the silicone component is a polyorganosiloxane containing the polar groups in sidechains.

12. The method of claim 8, wherein the silicone component is a random copolymer containing silicone units and ethylene units having the polar groups in sidechains.

13. The method of claim 8, wherein the silicone component contains from about 1 to about 30 wt % of the polar groups.

14. The method of claim 8, wherein the surface layer further comprises an infrared-absorbing filler.

15. A process for variable lithographic printing, comprising:
applying a fountain solution to an imaging member surface;
forming a latent image by evaporating the fountain solution from selective locations on the imaging member surface to form non-image areas and image areas;
developing the latent image by applying an ink composition comprising an ink component to the image areas; and
transferring the developed latent image to a receiving substrate;
wherein the imaging member surface comprises a silicone component having polar groups.

16. The process of claim 15, wherein the fountain solution is an aqueous solution, a silicone liquid, or a silicone oil.

17. The process of claim 15, wherein the fountain solution is D4.

18. The process of claim 15, wherein the polar groups are selected from the group consisting of cyano, hydroxyl, ether, carbonyl, amide, and sulfone groups.

19. The process of claim 15, wherein the silicone component is a polyorganosiloxane containing the polar groups in sidechains.

20. The process of claim 15, wherein the silicone component contains from about 1 to about 30 wt % of the polar groups.
